(19) United States
(12) Patent Application Publication
(10) Pub. No.: US 2003/0203076 A1
(43) Pub. Date: Oct. 30, 2003

(54) Heat-treated food which has been wrapped in a pastry of wheat flour dough for cooking in a microwave oven

(75) Inventors: Akihiro Watanabe, Gunma (JP); Hirofumi Terazaki, Gunma (JP); Yoshiki Matsuura, Gunma (JP); Nobuhiro Fusamune, Gunma (JP); Takehiko Uchida, Gunma (JP); Junko Gonda, Gunma (JP); Masata Mitsuiki, Gunma (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO. INC, Tokyo (JP)

(21) Appl. No.: 10/419,127

(22) Filed: Apr. 21, 2003

(30) Foreign Application Priority Data
Apr. 19, 2002 (JP) 2002-118102

(51) Int. Cl. A23G 3/00

(52) U.S. Cl. 426/94

(57) ABSTRACT

According to the present invention, there may be provided a heat-treated food which has been wrapped in a pastry of wheat flour dough for cooking in a microwave oven and which is capable of reproducing the so-called crispy feeling as well as favorable flavor and taste just cooked, said heat-treated food tending to migrate water to the heat-treated surface from the inside ingredients during its distribution and storage terms.

The present invention relates to a heat-treated food wherein the inside ingredients have been wrapped in a pastry of wheat flour dough for cooking in a microwave oven and whose heat-treated surface is in contact with a microwave heat susceptor.

### TECHNICAL FIELD

The present invention relates to a heat-treated food wherein the ingredients present in the inside have been wrapped in a pastry of wheat flour dough including a frozen baked gyoza (dumpling stuffed with minced pork) and a similar food for cooking in a microwave oven which is suitable for imparting a crispy texture to its heat-treated surface when heated and cooked in a microwave oven. More particularly, it relates to a heat-treated food which has been wrapped in the pastry whose heat-treated surface is in contact with a microwave heat susceptor which brings about heat generation effect by microwave energy whereby there is provided a food wrapped in a pastry which is capable of bring a crispy texture on its heat-treated surface after cooking in a microwave oven.

### PRIOR ART

Recently, there has been put on the marketplace in a large amount a heat-treated food which may be served to a table immediately by merely opening a container packing it or by a simple cooking such as heating by a microwave oven.

It is an important factor for determining the value of commodity as the heat-treated food that when a container packing it was opened and consequently it taken out from the container was served to a table, there may be reproduced a light palate feeling just baked, the so-called crispy texture on its heat-treated surface as well as a pleasant flavor immediately after cooked.

After the heat-treated food has been prepared, it is stored in a chilled or frozen state and delivered to consumers via distribution channels. Generally it is prepared on the condition that the storage term for the chilled product is about 2 weeks while that for the frozen product is at least a month, usually 2-3 months.

However, the migration of water occurs in heat-treated food during distribution and storage. Especially, in the case of food wrapped in a pastry such as a baked gyoza or the like, the migration of water to the pastry from the ingredients contained in the inside occurs and hence it is difficult to reproduce preferable flavor and taste and crispy texture when eaten. Also, various attempts have been made hitherto to reproduce preferable palate feeling when eaten after the distribution and storage of the heat-treated food.

For example, there is proposed a process wherein a wheat flour dough is rolled and the resultant rolled dough is then blended with 1-15% fats and oils having a melting point of 50-90° C. based on the dough whereby there can be prepared a food for frying in oil which is capable of maintaining a favorable palate feeling just after flying in oil for a long time (Japanese Patent Application Open-Laid No. Hei 3-30651). However, this process needs mixing the fats and oils having a high melting point with dough and hence the palate feeling of the dough is impaired owing to their little dissolution in the oral cavity There is also proposed a process wherein a wheat flour product is prepared using a dough containing a starch subjected to wet heat treatment and a saccharide and containing wheat flour as the main ingredient, the prepared product still retaining a good palate feeling without causing its heat-treated surface to become rubber-like tacky with thread and unpleasant shortness texture in a palate feeling even after the passage of time from a baking or flying treatment and further even by re-heating the chilled or frozen product using a microwave oven (Japanese Patent Application Open-Laid No. Hei 10-94373). However, since this process needs mixing the starch subjected to wet heat treatment and saccharide with wheat flour dough, not only restriction is imposed on the formulation of dough but also the change in palate feeling is caused because of a difficult moldability of dough.

There is proposed a process for preparing a wheat flour product having a shortness texture and a crispy heat-treated surface by kneading a dough containing fats and oils having a melting point of 40-60° C. and a starch subjected to wet heat treatment and subjecting the resultant dough to a heat treatment such as a baking or flying treatment (Japanese Patent Application Open-Laid No. Hei 10-80255). However, since this process needs mixing specific fats and oils and starch subjected to wet heat treatment with dough, not only restriction is imposed on the formulation of dough but also the change in palate feeling is caused because of a difficult moldability of, dough.

There is provided a process for preparing a frozen food having a heat-treated surface having an appropriate hardness, a favorable crispy texture without thread by using wheat flour as the main ingredient, regulating the dough for the frozen food so as to be 0.6-1.8 mm in thickness and to have 15-50 gf/mm in a ratio of a strength at break/a strain distance in the specific breakage measurement (Japanese Patent Application Open-Laid No. Hei 11-46709). However, this process needs adding a substance capable of drawing the gluten tissue in wheat flour tissue sufficiently and cutting its bondage properly together with a substance capable of preventing a starch from being denatured in order to bring the dough to have the specific ratio of a strength at break/a strain distance, and hence not only restriction is imposed on the formulation and the appearance of dough but also the change in palate feeling is caused because of a difficult moldability of dough.

Also, some attempts have been made to impart a scorched part and a crispy feeling to the frozen food during a microwave heat treatment by utilizing a microwave heat susceptor.

For example, there is an invention regarding a container for microwave cooking which is characterized by having formed a printed coating on the wall part of the container or a part of its cap with a printing ink containing potassium titanate reductant and metallic particles which reflects microwaves (Japanese Patent Application Open-Laid No. Sho 63-87534). However, the object of this invention is to produce cheaply on an industrial scale a container which is capable of imparting the scorched part into the food packed therein properly by a microwave cooking and it discloses an example of imparting the scorched parts to pizza, a preparation example of popcorn and an example of imparting the scorched parts of striped pattern around a rice ball. Thus it never intends to impart a crispy feeling into a food having the scorched part.

Also, there is a process for providing a plate-like baked wheat flour food having a crispy feeling on eating and a good taste even through heating in a microwave oven by laying a fat and oil layer between a plate-like baked wheat flour food and a microwave-heating body placed on at least one side of the upper and below sides of the baked wheat flour food (Japanese Patent Application Open-Laid No. Hei 03-210143). However, this process needs laying a fat and oil layer between a plate-like baked wheat flour food and a microwave-heating body and hence it has a default that the fat and oil content becomes sticky when eaten. Also, the solid fat and oil which is used as the preferred one becomes solid when the temperature of the product drops, thus it is not preferable.

Also, there is proposed a process wherein a high temperature heating may be attained sufficiently in a short time and especially a scorched part may be imparted on the surface of food by using a heating body for microwave heating at heat-cooking by microwaves (Japanese Patent Application Open-Laid No. 2000-279321). Although it discloses some examples of having imparted the intended scorched parts on the surface of food by subjecting a frozen gyoza and a frozen pizza to the microwave cooking using the heating body for microwave heating, it never intends to impart a crispy feeling into a food having a scorched part. Also, for imparting a scorched part into a food having no scorched part by a microwave cooking, not only it has the disadvantages that heating time becomes long and power consumption becomes large but also the risk of ignition by overheating becomes great, too.

### DETAILED EXPLANATION OF THE INVENTION

An object of the present invention is to provide a heat-treated food which has been wrapped in a pastry for cooking in a microwave oven which is capable of reproducing the so-called crispy feeling as well as favorable flavor and taste just cooked, said heat-treated food tending to migrate water to the heat-treated surface from the ingredients contained in the inside during distribution and storage terms.

The present invention is a heat-treated food which has been wrapped in a pastry for cooking in a microwave oven whose heat-treated surface is in contact with a microwave heat susceptor, and especially on the heat-treated surface of the heat-treated food wherein the water content in the ingredients contained in the inside and the thickness of the pastry have been respectively adjusted to the specific range is superposed a microwave heat susceptor which brings about the heat-generation effect by microwave energy whereby a crispy feeling can be reproduced on the heat-treated surface after cooking in a microwave oven, thus the above object may be achieved.

The present invention includes a series of inventions as defined below.

Invention 1: a heat-treated food wherein ingredients have been wrapped in a pastry of wheat flour dough for cooking in a microwave oven whose heat-treated surface is in contact with a microwave heat susceptor.

Invention 2: a heat-treated food wherein ingredients have been wrapped in a pastry of wheat flour dough for cooking in a microwave oven whose heat-treated surface is superposed on a microwave heat susceptor and wherein the value given when the water content (g) in the ingredients contained in the inside was divided by the area (cm²) of the heat-treated surface with respect to the heat-treated food obtained after cooking in the microwave oven lies in a range of 0.3-0.72 g/cm².

Invention 3: the heat-treated food as defined in the above invention 2 wherein the thickness of the pastry constituting the heat-treated surface after cooking in the microwave oven is 0.8-1.4 mm.

Invention 4: the heat-treated food as defined in the above inventions 1 to 2 wherein the heating value of the microwave heat susceptor is 30-300 J/cm².

Invention 5: the heat-treated food as defined in the above inventions 2 to 4 wherein the water content in the heat-treated surface after cooking in the microwave oven is 5-27%.

Invention 6: the heat-treated food as defined in the above inventions 2 to 5 wherein the gelatinizing extent of a starch in the heat-treated surface after cooking in the microwave oven is 60-98%.

Invention 7: the heat-treated food as defined in the above inventions 1 to 6 wherein the heat-treated food is a frozen food.

Invention 8: the heat-treated food as defined in the above inventions 1 to 6 wherein the heat-treated food is a frozen gyoza.

The terms “a food wrapped in a pastry of wheat flour dough” in the present invention indicates the food wherein the ingredients present in the inside has been wrapped or enclosed in a pastry of wheat flour dough. The main raw material for the pastry is grain flour such as wheat flour while the sub-raw material for use includes an oil and fat, sodium chloride, saccharides, a seasoning, etc. Specific examples of the food wrapped in a pastry of wheat flour dough include a gyoza, a shao-mai., Chinese dumpling, ravioli, spring roll and the like.

The pastry of wheat flour dough may be prepared according to the process known in the art. In general, after the kneading operation has been applied to grain flour containing wheat flour as the main ingredient, the subsequent rolling and molding operations are applied thereto depending on the intended product.

Also, the food wrapped in a pastry of wheat flour dough and subjected to a heat treatment includes one being in a chilled or frozen state after its preparation. Example of the frozen one is a frozen gyoza, said gyoza being prepared by wrapping or enclosing the ingredients such as minced and seasoned vegetable, pork and the like in a pastry comprised wheat flour as the main ingredient and subjecting the resultant wrapped or enclosed food to heating treatment for cooking.

The terms “a microwave heat susceptor” in the present invention means one having a characteristic property of generating heat by absorbing microwave energy and converting it into heat. As examples of such a microwave heat susceptor there may be taken electrically conductive metal deposited layer—provided plastic film or paper substrate (see Japanese Patent Application Open-Laid Nos. Sho 60-251056 and 2000-279321). Of course, it is not limited thereto. The shape of the microwave heat susceptor is not particularly limited but may be e.g. sheet, plate, tray, foil, etc. Usually, it is recommendable to be in such a shape that it conducts heat to the heat-treated surface of the food well. In the case that the heat-treated surface is flat, it may also be plate-like shape thereby heat is easily transmissible to the heat-treated surface. It may be also used in the form of sheet having fine holes or a slot.

Also, the terminals of the microwave heat susceptor may be possessed as be folded so as not to cause the part superposed on the heat-treated surface of the food to bend.

The terms “the heat-treated surface” referred to herein indicates the surface to which heat treatment was applied during its step after a food wrapping or enclosing in the pastry has been molded into the desired shape. The thickness of the pastry constituting the surface to be heat-treated is required to be 0.8-1.4 mm, preferably 0.8-1.1 mm in order to evaporate out water contained therein rapidly by the heat treatment.

In the present invention, prior to the heat-treatment step there may be applied batter-adhering step for the purpose of imparting a favorable crispy feeling into the heat-treated surface, water-adding step for the purpose of making the heat-treated surface flat and of imparting a uniform scorched part thereto or a fat and oil-adding step for the purpose of preventing burning.

It is preferable that water content in the heat-treated surface after cooking in the microwave oven is 5-27% in order to reproduce crispy texture on the heat-treated surface. The terms “water content in the heat-treated surface” in the present invention mean the water content in the heat-treated surface when the food was heated for a minute and 50 seconds with a 600W microwave oven while its heat-treated surface was in contact with a microwave heat susceptor, the total weight of the frozen food to be subjected to the microwave heating being 80 g. The measurement for the amount by weight of water is conducted by drying the frozen food for 4 hours at 105° C.

Although a means for imparting a scorched part to the heat-treated surface is not limited particularly, it is preferable to apply heat treatment using an iron plate because of its easy operation in applying heat treatment at an elevated temperature and its easy heating for the heat-treated surface being flat in microwave cooking with the microwave heat susceptor.

As the heating value of the microwave heat susceptor is high, the water content in the heat-treated surface may be adjusted to the desired range as above-stated in a shorter time. However, it is preferable that the heating value of the microwave heat susceptor is 30-300 J/cm² for maintaining the favorable palate feeling (crispy feeling) when cooking under the prescribed condition at a restaurant, home, etc. e.g. for a minute and 50 seconds using a 600W microwave oven.

The inside ingredients for use in the present invention may be ones which lie in a range of preferably 03-0.72 g/cm², more preferably 0.3-0.6 g/cm² in terms of the value given when the weight (g) of water contained therein after cooking in the microwave oven was divided by the area (cm²) of the heat-treated surface at that time.

The water contained in the heat-treated surface may be evaporated out using the microwave heat susceptor in the present invention. In some cases, the water (free water) contained in the inside ingredients migrates to the heat-treated surface. To reduce the amount of the inside ingredients or to mix a water-retaining agent with the inside ingredients thereby converting free water into the bound water is effective for prevent the migration of water to the heat-treated surface from the inside ingredients.

After the food wrapping in the pastry has been molded into the desired shape, it is subjected to heat treatment for cooking. With respect to the surface to be subjected to the heat treatment, the gelatinizing extent of starch during the heat treatment is adjusted to such a high value that it becomes about 60-98% after cooking in the microwave oven whereby there can be obtained the desired food product having a favorable crispy texture and shortness texture.

The present invention is further illustrated specifically by the following examples. However, the present invention is not restricted to these examples.

### EXAMPLE 1

TABLE 1

| | |
|---|---|
| Wheat flour | 100 parts by weight |
| Water | 36 parts by weight |
| Sodium chloride | 1 parts by weight |

The composition based on the formulation shown in table 1 was sufficiently mixed with a mixer and kneaded for 10 minutes and thereafter the resultant wheat flour dough was rolled to the final thickness between 0.5 mm and 1.2 mm and stamped thereby preparing a pastry. The inside ingredients were prepared by mincing vegetable and pork and mixing with a seasoning, and 8 to 20 g of the prepared inside ingredients was wrapped in the pastry to mold a gyoza. Next, a batter comprising a starch and a fat and oil was adhered to the bottom of the molded gyoza and the gyoza was subjected to steam and shallow fry for 4 minutes on a flying pan. Thereafter, a small amount of oil was poured thereto and the gyoza was baked. It was frozen in a rapid freezer and stored for a given term at −18° C. And then, the frozen baked gyoza was heat-cooked for a minute and 50 seconds using a 600 W microwave oven with or without superposing a microwave heat susceptor on its baking surface and a sensory evaluation for the palate feeling (crispy feeling) was made. The sensory evaluation was made using a 5-point rating scale based on the following criteria.

1 point: very bad

3 point: ordinary

5 point: very good

Five panelists made the evaluation and the evaluation score was expressed in the average score.

### EXAMPLE 1

### Effect of the Microwave Heat Susceptor

Sensory evaluation made after 3 months indicates the sensory evaluation was made with respect to palate feeling after the gyozas have been frozen at −18° C. and stored for 3 months in frozen state.

Also, as the microwave heat susceptor, a heat generating body (a product of TRYKKO PACK Company, Denmark) was used in the form of plate, said heat generating body having been prepared by depositing a material containing aluminum as the main ingredient on a paper having an areal weight of 369 g and coating with polyethylene terephthalate (PET) for protecting the surface.

TABLE 2

| Thickness of pastry | Thickness | Sensory evaluation | |
|---|---|---|---|
| When molded | of pastry | after 3 months | |
| (Before heat | After microwave | Heat generating | Heat generating |
| Treatment) (mm) | Cooking (mm) | Body Exists | Body Nothing |
| 0.5 | 0.9 | 3.58 | 2.14 |
| 0.6 | 1.0˜1.1 | 3.7 | 2.16 |
| 0.7 | 1.2˜1.4 | 3.46 | 2.46 |
| 0.8 | 1.3˜1.4 | 3.4 | 2.32 |

The results are summarized in table 2. As seen from the results, there was no difference in the palate feeling among pastries having different thickness but the existence of the heat generating paper gave very favorable palate feeling (crispy feeling) irrespective of the thickness of the pastry.

Incidentally, the statistical processing revealed that there is a significant difference (P<0.01) in the palate feeling of the pastries between the case where the heat generating body exists and the case where it does not exist.

### EXAMPLE 2

### Effect of the Thickness of the Heat-Treated Surface

The thickness of the pastry for gyoza when molded (before heat treatment) was measured. After various gyozas having different thickness of pastries were stored for a month in a frozen state of −18° C., the frozen gyozas were subjected to the microwave cooking while the heat-treated surface of each frozen gyoza was superposed on the heat generating body. And thereafter, the thickness of the pastry was measured and the sensory evaluation for the palate feeling was made. As the result, the increase in the thickness of the pastry did not cause it to swell sufficiently even after the heat treatment. It is considered that the gelatinization of starch in the heat-treated surface did not occur sufficiently.

TABLE 3

| Thickness of pastry | Thickness of pastry | |
|---|---|---|
| When molded (Before | When molded (Before | Sensory evaluation |
| heat treatment) (mm) | heat treatment) (mm) | After a month |
| 0.5 | 0.9 | 3.22 |
| 0.6 | 1.0˜1.1 | 3.40 |
| 0.7 | 1.2˜1.4 | 3.14 |
| 0.8 | 1.3˜1.4 | 3.10 |
| 1.0 | 1.3˜1.4 | 2.95 |
| 1.2 | 1.3˜1.4 | 2.88 |

The results are summarized in table 3. As seen from the results shown in table 3, the pastry having a thickness of below 0.8 mm, preferably below 0.6 mm when molded gives a favorable palate feeling, while after the microwave cooking the pastry having a thickness of 0.8-1.4 mm, preferably 0.8-1.1 mm gives a favorable palate feeling (crispy feeling).

### EXAMPLE 3

### Influence of the Content of Water in the Inside Ingredients

With respect to the gyozas subjected to the microwave cooking, the content of water in the inside ingredients per unit area of the heat-treated surface was calculated. The terms “the content of water in the inside ingredients” referred to herein indicate the values given by multiplying the measured value for the content of water in the inside ingredients by the weight of the inside ingredients.

The gyozas stored in a frozen state for a month or 3 months which are different in the content of water in the inside ingredients per unit area of the heat-treated surface were subjected to the microwave cooking while the heat generating body was superposed on the heat-treated surface. And thereafter, the sensory evaluation for the palate feeling (crispy feeling) was made.

TABLE 4

| Content of water | | |
|---|---|---|
| In the inside ingredients/ | Sensory evaluation | Sensory Evaluation |
| Area of the heat-treated | (After the storage | (After the storage |
| Surface (g/cm²) | For a month) | For 3 months) |
| 0.37 | 3.38 | 3.48 |
| 0.58 | 3.33 | 3.40 |
| 0.71 | 3.18 | 3.18 |
| 0.75 | 3.05 | 2.83 |

The results are summarized in table 4. As the results, there was a good palate feeling (crispy feeling) when the content of water in the inside ingredients per unit area of the heat-treated surface is below 0.72 g/cm². And there was better palate feeling (crispy feeling) when it is below 0.6 g/cm².

### EXAMPLE 4

### Effect of Heat Value of Heat Generating Body

The frozen gyozas were cooked for a minute and 50 seconds in a 600 W microwave oven while the heat-treated surface was superposed on various heat generating bodies having different heat values. For comparison, they were cooked for a minute and 50 seconds in a 600 W microwave oven without accompanying any heat generating body. And thereafter, the sensory evaluation for the palate feeling (crispy feeling) was made.

The preparation of the gyozas was conducted according to the similar manner as in Example 1. The heat generating body composed a material containing aluminum as the main ingredient deposited paper was used in the form of plate. Herein, the heat value of the heat generating body was adjusted by the amount of paper, the amount deposited of the material containing aluminum as the main ingredient and by the presence or absence of PET.

TABLE 5

| | Heat value^{(*1)} | Sensory |
|---|---|---|
| | (J/cm²) | Evaluation |
| Control | — | 2.5 |
| Heat generation body 1 | 58.9 | 3.4** |
| Heat generation body 2 | 50.1 | 3.2** |
| Heat generation body 3 | 47.1 | 3.2** |
| Heat generation body 4 | 42.1 | 3.2** |
| Heat generation body 5 | 30.2 | 3.3** |
| Heat generation body 6 | 13.8 | 3.0* |

Control: wood-free paper
^{(*1)}The quantity of heat of the heat generating body was calculated from the temperature raised for 20 g of salad oil per cm² of the heat generating body (a specific gravity: 1680 J/Kg ° C.) when heated for 30 seconds in a 500 W microwave oven.
*P < 0.05
**P < 0.01

The results are summarized in table 5. As the results, higher the heat value of the heat generating bodies better the palate feeling. In this case, as a result of the statistical processing for the evaluation scores given respectively when the heat generating body was present and when it was absent, there was recognized a significant difference (P<0.01) in the evaluation scores for the heat generating bodies having 30.3-58.9 J/cm². Also, when using a heat generating body having too high heat value, the pastry scorches prior to warming up of the inside ingredients. It is preferable from these results that the heat value of the heat generating body is 30-300 J/cm².

### EXAMPLE 5

### Water Content in the Heat-Treated Surface After the Microwave Cooking

Various gyozas having different water contents in the heat-treated surface were stored in a frozen state for a month and thereafter subjected to microwave cooking while each of their heat-treated surfaces was superposed on a heat generating body. And then, the water content in the heat-treated surface was measured and the sensory evaluation was made with respect to the palate feeling (crispy feeling).

TABLE 6

| | Sensory evaluation |
|---|---|
| Water content in the | (After the storage |
| Heat-treated surface (%) | For a month) |
| 18.12 | 3.38 |
| 21.58 | 3.40 |
| 25.90 | 3.18 |
| 36.31 | 2.70 |

The results are summarized in table 6. It became clear that when the water content in the heat-treated surface is more than 27%, the palate feeling (crispy feeling) is lowered. It is preferable from the result that the water content in the heat-treated surface is in a range of 5-27%.

### EXAMPLE 6

### Influence of the Gelatinizing Extent of Starch in the Heat-Treated Surface

Gyozas molded in similar manner as in Example 1 were subjected to steam and shallow fry for an adjusted time between 4 minutes and 7 minutes on a flying pan. And thereafter, a small amount of oil was poured into the flying pan and gyozas were baked. And the baked gyozas were frozen in a rapid freezer and the frozen products were stored for a given term (3 months) at −18° C. They were cooked for a minute and 50 seconds in a 600 W microwave oven and subjected to the measurement of the gelatinizing extent of starch in the heat-treated surface and to sensory evaluation. The measurement of the gelatinizing extent of starch in the heat-treated surface was conducted according to K. Kainuma et. al.' method (Starch Science, 28 (4), 235-240 (1981)). In the sensory evaluation, shortness texture in addition to the crispy feeling was evaluated.

The sensory evaluation for the shortness texture was made using a 5-point rating scale based on the following criteria:

1 point: very bad

3 point: ordinary

5 point: very good

TABLE 7

| | |
|---|---|
| Gelatinizing | Sensory evaluation |

| Extent of | Crispy | Shortness |
|---|---|---|
| Starch (%) | feeling | texture |
| 67.21 | 3.82 | 3.40 |
| 64.01 | 3.62 | 3.20 |
| 57.10 | 3.30 | 2.80 |
| 55.31 | 3.12 | 2.96 |
| 61.00 | 3.40 | 3.10 |

The results are summarized in table 7. As is seen from the results, there were obtained gyozas combining good crispy feeling and shortness texture when the gelatinizing extent of starch in the heat-treated surface is more than about 60%. The correlation coefficient between the gelatinizing extent of starch and the evaluation score for crispy feeling and that between the gelatinizing extent of starch and the evaluation score for shortness texture were calculated to be 0.99, 0.92, respectively. Thus it was recognized that there is a close correlation relationship between the sensory evaluation score and the gelatinizing extent of starch. Accordingly, by causing the heat-treated surface to gelatinize sufficiently, preferably to such an extent that the gelatinizing extent of starch becomes more than 60%, a good crispy feeling and a shortness texture may be achieved.

### EFFECT OF THE INVENTION

By a microwave cooking according to the present invention, there can be prepared a heat-treated food which has been wrapped in a pastry of wheat flour dough and which has good flavor and taste and a juicy texture and whose heat-treated surface has a crispy texture. And, the heating and cooking in the microwave oven has an advantage that cooking can be completed in a very short time as compared with the re-heating on a flying pan, etc.

1. A heat-treated food which has been wrapped in a pastry of wheat flour dough for cooking in a microwave oven whose heat-treated surface is in contact with a microwave heat susceptor.

2. A heat-treated food which has been wrapped in a pastry of wheat flour dough for cooking in a microwave oven whose heat-treated surface is superposed on a microwave heat susceptor and wherein the value given by dividing the weight (g) of the water contained in the inside ingredients divided by the area (cm²) of the heat-treated surface with respect to the heat-treated food obtained after cooking in the microwave oven lies in a range of 03-0.72 g/cm².

3. The heat-treated food as claimed in claim 2 wherein the thickness of the pastry constituting the heat-treated surface after cooking in the microwave oven is 0.8-1.4 mm.

4. The heat-treated food as claimed in any one of claims 1 and 2 wherein the heating value of microwave heat susceptor is 30-300 J/cm².

5. The heat-treated food as claimed in any one of claims 2 to 4 wherein the water content in the heat-treated surface after cooking in the microwave oven is 5-27%.

6. The heat-treated food as claimed in any one of claims 2 to 5 wherein the gelatinization extent of starch in the heat-treated surface after cooking in the microwave oven is 60-98%.

7. The heat-treated food as claimed in any one of claims 1 to 6 wherein the heat-treated food which has been wrapped in a pastry of wheat flour dough is a frozen food.

8. The heat-treated food as claimed in any one of claims 1 to 6 wherein the heat-treated food which has been wrapped in a pastry of wheat flour dough is a frozen gyoza.
